(19) United States
(12) Patent Application Publication
(10) Pub. No.: US 2012/0229099 A1
(43) Pub. Date: Sep. 13, 2012

(54) System for Storing Electrical Energy

(76) Inventor: Conrad Rossel, Syrgenstein (DE)

(21) Appl. No.: 13/391,616

(22) PCT Filed: Jul. 16, 2010
(86) PCT No.: PCT/EP2010/004353

§ 371 Date: Apr. 25, 2012

(30) Foreign Application Priority Data
Aug. 27, 2009 (DE) 102009039161.4

(51) Int. Cl. H02J 7/00

(52) U.S. Cl. 320/162; 320/167

(57) ABSTRACT

The invention concerns a system for storing electric energy, which comprises a plurality of storage cells, which have each an operating voltage. An electrical load as well as a switching element in series with the device are arranged in parallel to a storage cell. The switching element is closed when reaching or exceeding a threshold voltage. The system moreover includes a control device, which is arranged in order to adjust the threshold voltage depending on a voltage value established from operating voltages of the plurality of the storage cells. A storage cell for storing electric energy as well as a method for controlling a system designed for storing electric energy with a plurality of storage cells are also provided.

The invention concerns a system for storing electric energy as defined more in detail in the preamble of claim 1. The invention moreover concerns a system for storing electric energy.

Systems for storing electric energy, and here in particular for storing electric traction energy in electric vehicles or in particular in hybrid vehicles, are known from the general state of the art. Such systems for storing electric energy typically include individual storage cells which are for instance electrically linked together in series and/or in parallel.

Various accumulator cells or capacitor cells can basically be contemplated as storage cells. Due to the comparatively high energy amounts and in particular to the high performances, which occur for storing and tapping energy in case of use in drive trains of vehicles and here in particular of utility vehicles, the storage cells used are preferably those with sufficient energy content and high performance. To do so, accumulator cells can for instance be used in the lithium-ion technology or in particular storage cells in the form of very powerful double-layer capacitors. These capacitors are designated in professional circles also as supercapacitors, supercaps or ultracapacitors. Regardless of whether conventional supercapacitors or accumulator cells with high energy content are now used, the voltage of the various storage cells, due to their design, is limited to an upper voltage value or a threshold voltage, with current assemblies consisting of a plurality of storage cells which can be linked as a whole or also in blocks in series to one another. The lifetime of the storage cell generally decreases drastically if said upper voltage value is exceeded for instance when charging the system for storing electric energy.

Due to preset manufacturing tolerances, the individual storage cells typically deviate slightly in practice in their properties from each other for instance in terms of self-discharge. The consequence is that in service a slightly smaller operating voltage than for other storage cells can be available in the system for individual storage cells. Since the maximum voltage however remains equal generally for the whole system and the maximum total voltage represents the typical actuation criterion in particular during charging, the effect is invariably that other storage cells which are connected in series to the storage cells with lower operating voltage, have a somewhat higher voltage and are charged beyond the admissible individual maximum voltage limit during charging processes. Such an overvoltage leads, as already mentioned above, to a considerable reduction in the possible lifetime of said individual storage cells and hence also of the whole system for storing electric energy.

On the other hand, storage cells whose voltage has been strongly lowered can have their polarity reversed in the system for storing electric energy in cyclic operation, which also drastically reduces the lifetime.

To cope with such problems, the general art mainly offers two different types of so-called cell voltage balances. The generally usual terminology of the “cell voltage balance” is here somewhat deceptive since here voltages or more precisely energy contents of the individual storage cells are not balanced to one another, but the cells with too high voltages see their voltages reduced. Since the total voltage of the system for storing electric energy remains constant, a cell whose voltage has been lowered, can be restored over time to its voltage via the so-called cell voltage balance so that at least the danger of polarity reversal is excluded.

In addition to a passive cell voltage balance at which an electric resistor is switched in parallel to each individual storage cell and there being consequently a steady undesirable discharge as well as a heating of the system for storing electric energy, an active cell voltage balance is also applied. To do so, in addition to the resistor connected in parallel to each individual storage cell, an electrical threshold switch is connected in parallel to the storage cell and in series to the resistor. Said assembly, also designated as a by-pass electronic assembly, hence only lets current flow, when the operating voltage of the cell lies above a preset threshold voltage. As soon as the voltage of the individual storage cell returns to a region below the preset threshold voltage, the switch opens and no current flows any longer. Due to the fact that the electrical resistor is always deactivated via the switch when the voltage of the individual storage cells is below the preset limit value, an undesirable discharge of the whole system for storing electric energy can extensively be avoided. Also a steady undesirable heat generation is not a problem with that approach to the active cell voltage balance.

Indeed, said active cell voltage balance does not induce any actual balance of the various voltages of the cells relative to one another, but the storage cell is discharged with a small by-pass current in case the threshold voltage has been exceeded, so as to limit the excess by slowly reducing the overvoltage. The by-pass current then only flows as long as the system for storing electric energy is discharged again, since the voltage in this context falls below the corresponding limit and the switch opens again. This can be seen in particular in applications with cyclic operation, such as for example hybrid drives, since in these application cases the threshold voltage for the individual storage cell is only achieved for a very short time or is not achieved at all for a significant length of time if the storage device is not completely charged due to a lack of recuperation and during a strong boost operation. This prevents the cell voltage balance from operating and in particular entails the risk of a deep discharge or of a polarity reversal of the various storage cells with lower operating voltage while the other cells are operated at too high voltage.

The lifetime of the system for storing electric energy is of vital importance with the described hybrid drive and here in particular with hybrid drives for utility vehicles such as omnibusses in urban and local traffic. Unlike with conventional drive trains in the performance category appropriate for such applications, the system for storing electric energy represents a considerable portion of the costs for the hybrid drive. It is hence especially important that quite high lifetimes can be achieved with such applications.

It is hence an object of the invention to provide a system for storing electric energy, which at least partially avoids the described shortcomings and includes an efficient cell voltage balance in particular in cyclic operation.

This object is satisfied by a system and a method having the characteristics of the independent claims. Further embodiments of the invention are disclosed in the dependent claims.

In particular, the invention sets forth a system for storing electric energy, comprising a plurality of storage cells, which have each an operating voltage, whereas an electrical load as well as a switching element in series with the device are arranged in parallel to a storage cell, whereas the switching element is closed when reaching or exceeding a threshold voltage. The system is characterised in that it includes a control device, which is arranged in order to adjust the threshold voltage depending on a voltage value established from operating voltages of the plurality or of all storage cells.

It is hence possible according to the invention to adjust the threshold voltage for instance of each of the storage cells by means of the control device on a voltage value which can be derived from the current operating condition of the storage cells, i.e. from their operating voltages. The plurality of storage cells may be for instance a module or a submodule of a larger storage system or the entirety of all storage cells of a system for storing electric energy. The voltage value determined from the operating voltages of the plurality or from all the storage cells may be for instance the average cell voltage, a determined average cell voltage or an average cell voltage which is modified by a variable value. Such a dynamic adaptation of the threshold voltage depending on the actual charge level of the system for storing electric energy or of a module of the system can set for example the threshold voltage constantly by 0.1 V above the currently prevailing average voltage. Such tracking of the threshold voltage sets forth that individual storage cells with increased cell voltage are discharged, independent of the charge level of the module or of the whole system.

The amount of voltage which is added to the average voltage value can be a fixed amount. But it can also be selected for instance depending on the absolute total voltage or depending on the actual operating mode or depending on surrounding or any other parameters. It can thus be provided for instance that a comparatively high voltage value is added in the presence of a globally low voltage level of the storage system, whereas conversely a smaller amount of voltage is added in the vicinity of the upper absolute threshold voltage limit. This guarantees that the quantity of energy used for the cell voltage balance in the presence of a low total voltage level is not too high while said quantity of energy should not be exceeded in the voltage range close to the maximum voltage of the individual storage cell. In addition to the adjustment of the threshold voltage depending on operating voltages of the plurality of the storage cells, it can also be provided that additionally a threshold voltage value is applied, which is independent of the operating voltages of the plurality of the storage cells, which guarantees that a maximum operating voltage can be exceeded independent of the voltage value derived from the plurality of the storage cells. But this absolute upper maximum threshold voltage value can also depend of the operating condition of the whole system, of individual modules or on the current requirements profile of the storage device or still on the surrounding or any other system parameters, such as the surrounding temperature or the system temperature.

A central control device for several storage cells can be provided in one embodiment of the system according to the invention. One or several centrally controlled storage modules can hence be formed in terms of fixing the threshold voltage, modules whose threshold voltage can be controlled inside the module uniformly, but for instance distinctly for each module.

In a further embodiment according to the invention, the control device is set up in order to form a common voltage value out of a plurality of operating voltages of storage cells and to adjust the threshold voltage of the plurality of storage cells to a value which encompasses the common voltage value. In addition to the possibility just mentioned of forming an average value out of the operating voltage values of the plurality of storage cells and of applying it as such or after addition of a set or variable portion, other parameters can be taken into account into the calculation of the threshold voltage on top of these operating voltage values. So the current power output or input profile as well as a past power profile or a future power profile to be expected, can be taken into account into the calculation of the threshold voltage value.

In the system according to the invention, it can be provided that the control device adjusts the threshold voltage at determined intervals. Such a temporal scan of the system or of the detected module enables still enhanced voltage control of the storage cells with a minimal amount of control. The time interval between two scans can thus for instance be adapted to the sequence of the total voltage of the system or of the module or to the height of the total voltage.

It can also be provided in an embodiment that the control device continuously controls the threshold voltage. Such a real-time adaptation of the threshold voltage guarantees the maintenance of the set threshold voltage at any time and hence reduces any excessive voltage of individual storage cells which may occur. The threshold voltage value can be adjusted in particular not only as a control unit but also as a closed regulating circuit.

An equally advantageous embodiment of the invention sets forth that the switching element has a control input so as to control the threshold voltage. The switching element can be controlled by means of the control input via the control device which may be arranged centrally.

A preferred embodiment sets forth that the control device is connected to the storage cell by means of a bus line. This enables efficient actuation of a plurality of storage cells, whereas not only a modified threshold voltage value can be forwarded from the control device to the storage cell, but also the current operating voltage value can be forwarded from the storage cell to the control device. This enables to create a precise replication of the storage level of the system for storing electric energy to be more accurate of each detected module of the system.

In a simple embodiment of the invention, the load is a resistor, but also other means for evacuating electric energy, such as for instance by means of beamed radiation can be provided. The storage cell can be designed as a so-called supercapacitor, i.e. as a double-layer capacitor. In a simple embodiment, the switching element can be a threshold switch. The threshold of the threshold switch can thus be adjusted via the control device by means of a signal or data bus. To do so, the control input of the switching element can be applied in particular.

The actuation of the switching element through a control device can include can a contact-free transmission unit, in particular an isolation amplifier. The isolation amplifier can for instance be realised by an optocoupler or also by an inductive coupling and thus enable actuation of the switching element, separate from the storage cells by galvanisation. Consequently, the threshold voltage can be forwarded directly to the storage cell or an activation signal for the switching element can also be forwarded.

The object mentioned initially is also solved with a storage cell for storing electric energy, with an electrical load which is arranged parallel to the storage cell as well as with a switching element which is arranged in series with the device, whereas the switching element is closed when reaching or exceeding a threshold voltage. According to the invention it is provided that the switching element has a control input for controlling the threshold voltage. The current operating voltage of the storage cell as well as of additional storage cells which may be arranged in a module, can be fed into a central control device, by means of the control input, to be processed therein and the threshold voltage of the storage cell can be accordingly adjusted using the detected operating voltages via the control input.

The object mentioned above is solved by a method for controlling a system designed for storing electric energy with a plurality of storage cells, which respectively have a storage device voltage, whereas an electrical load as well as a switching element are arranged in series with the device in parallel to a storage cell, including the steps of charging the storage cells, of comparing the operating voltage of a storage cell having a threshold voltage as well as of closing the switching element, in case when the operating voltage has reached or exceeded the threshold voltage. With the method according to the invention it is provided that the threshold voltage is adjusted depending on a voltage value established from operating voltages of the plurality of the storage cells.

Additional advantageous embodiments of the system according to the invention of the storage cell according to the invention and/or of the method according to the invention are provided moreover in the exemplary embodiment, which is described more in detail below in the light of the figures.

The figures are as follows:

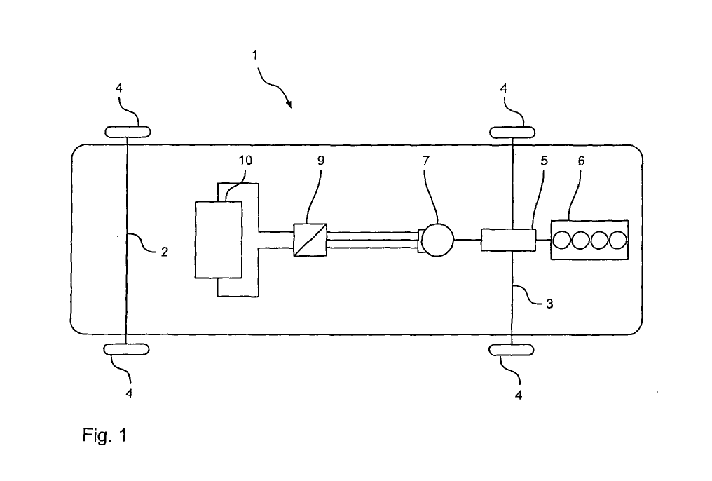

FIG. 1 is an exemplary assembly of a hybrid vehicle; and

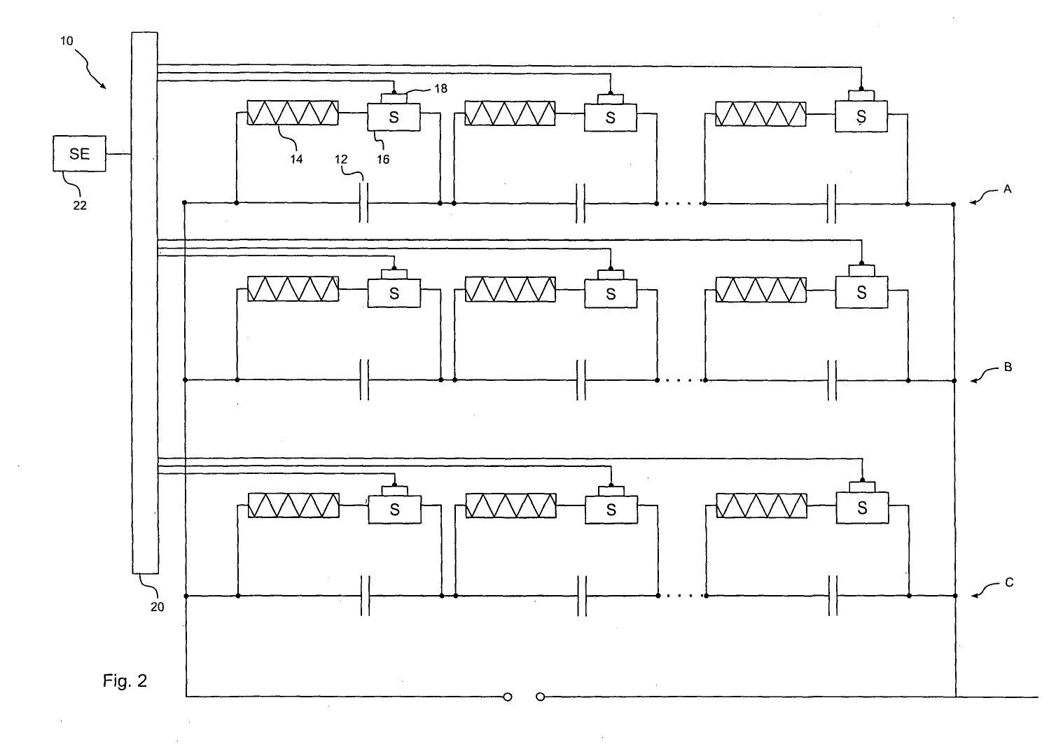

FIG. 2 is a diagrammatical illustration of an embodiment of a system for storing electric energy.

FIG. 1 refers to an exemplary hybrid vehicle 1. It has two axles 2, 3 each with two wheels 4 indicated by way of example. The axle 3 should hence be a driven axle of the vehicle 1, while the axle 2 exclusively rotates therewith in a manner known per se. A transmission 5 is represented by way of example for driving the axle, a transmission which picks up the power from a internal combustion engine 6 and from an electrical machine 7 and conveys it into the region of the driven axle 3. In service, the electrical machine 7 on its own or in complement to the drive power of the internal combustion engine 6 can guide the drive power into the region of the driven axle 3 and hence drive the vehicle 1 or support the actuation of the vehicle 1. Moreover, the electrical machine 7 can be operated moreover as a generator when braking down the vehicle 1 so as to recover the power produced during when braking and to store it accordingly. To be able to supply a sufficient energy content for instance when using the vehicle 1 as a city bus, as well as for braking processes from higher speeds which can reliably be of the order of max. 70 km/h, a system 10 for storing electric energy should be provided for such a case with an energy content in the order of magnitude of 350-700 Wh. This enables to store energies which for instance occur with a braking cycle of around 10 seconds from said speeds, which can be converted into electric energy, via the electrical machine 7, which typically have an order of magnitude of approx. 150 kW.

For operating the electrical machine 7 as well as for charging or discharging the system 10 for storing electric energy, the assembly according to FIG. 1 has a rectifier which is designed in a manner known per se with an integrated control device for energy management. The energy flow between the electrical machine 7 and the system 10 for storing electric energy is accordingly coordinated via the converter 9 with the integrated control device. The control device sees to it that when braking, the power produced in the region of the electrical machine 7 which is driven by a generator, is then, as much as possible, stored into the system 10 for storing electric energy whereas a preset upper voltage limit of the system 10 generally should not be exceeded. In service, the control device in the converter 9 coordinates the tapping of electric energy from the system 10, in order in this reverse case to drive the electrical machine 7 by means of this tapped power. In addition to the hybrid vehicle 1 described here, as it can be designed for instance as a city bus, it goes without saying that a comparable assembly could also be envisioned in a pure electric vehicle.

FIG. 2 shows diagrammatically a cut-out of a system 10 according to the invention for storing electric energy according to an embodiment. As a matter of principle, different types of the system 10 for storing electric energy can be envisioned. Such a system 10 is typically built up in such a way that a plurality of storage cells 12 are connected in the system 10 typically in series. These storage cells can hence be accumulator cells and/or supercapacitor cells or any combination thereof. For the exemplary embodiment represented here, all of the storage cells 12 can be designed as supercapacitors, that is to say as double-layer capacitors, which are installed in a single system 10 for storing electric energy in the vehicle 1 equipped with the hybrid drive. But the assembly can preferably be mounted in a utility vehicle, for instance an omnibus for the city and local traffic.

In this context, frequent starting and braking maneuvres in connection with a very high vehicle mass enable to achieve a particularly highly efficient storage of electric energy through the supercapacitors since comparatively high currents flow. Since supercapacitors as storage cells 12 have much smaller internal resistance than for instance accumulator cells, the former should hence be preferred for the exemplary embodiment which is described in more detail here.

As already mentioned, the storage cells 12 can be seen in FIG. 2. In that case, only three of several storage cells 12 connected in series are depicted. These form in a row of storage cells (not shown further) a first module A. Additional modules B, C are also depicted schematically. The exact number of modules varies depending on the intended use of the system. In the exemplary embodiment above and with a corresponding electrical drive power of about 100-200 kW, for instance 120 kW, this would mean in a realistic assembly a total of approximately 150-250 storage cells 12. If these are designed as supercapacitors with a current upper voltage limit of about 2.7 V per supercapacitor and a capacity of 3000 Farads it would provide a realistic application for the hybrid drive of a city omnibus.

As illustrated in FIG. 2, each of the storage cells 12 has an electrical device connected in parallel to the respective storage cell 12 in the form of an ohmic resistor 14. Said load is connected in series with a switching element 16 in parallel to each of the storage cells 12, in such a case in parallel to each of the supercapacitors 12. The switch 16 is designed as a threshold switch and has a control input 18. The switching element 16 comprises a voltage monitoring of the supercapacitor 12. As soon as the supercapacitor 12 exceeds an upper threshold voltage the switch 16 is closed so that a current can flow from the supercapacitor 12 over the resistor 14. To do so, the charge situated in the capacitor and hence the voltage are reduced accordingly, so that the threshold voltage value is not exceeded again at the same supercapacitor 12.

A central control device 22 is additionally provided. It is connected to a bus 20 to which in turn all the storage cells 12 are connected. The control device is designed to activate the switching elements 16 arranged on the storage cells by means of the bus 20, via the respective control input 18 so as to be able to adjust the threshold voltage for each storage cell 12. Conversely, the control device 22 can detect the current operating voltage of each storage cell 12 via the bus 20, using the operating voltage detection of the switching element 16 inasmuch as a corresponding signal or corresponding data as passed to the bus 20 and hence to the control device 22 via the control input.

If now operating voltages which significantly deviate from each other occur with the system 10 in operation possibly due to different internal resistances or due to other construction-related differences between the storage cells 12, said operating voltages are transferred to the control device 22 via the bus 20. The control device 22 determines the valid average operating voltage value, respectively for one of the modules A, B or C, out of these individual operating voltage values of the various storage cells 12. This established a threshold voltage which is valid for the storage cells in the respective module A, B, C for instance in such a way that a fixed amount of voltage value or an amount of voltage value depending on the current operating mode is added to the average value. Alternately, the arithmetically established average value can also be used exclusively. This thus calculated threshold voltage value is transferred from the control device 22 via the bus 20 to the storage cells 12 of the respective module. If various storage cells 12 are now situated above said threshold voltage value, the respective switching element 16 closes and the charge contained in the storage cell 12 is reduced via the ohmic resistor 14 which also enables the reduction in the operating voltage of the storage cell 12. If a greater number of storage cells are situated in the respective module A, B, C above the threshold voltage established from the average operating voltage value the average value decreases through the discharge of individual storage cells 12. The control unit 22 again calculates a lower threshold voltage from said reduced average value, transfers said voltage via the bus 20 and the control input 18 to the respective switching element 16. The operating voltages of storage cells 12 adapt themselves in this manner to the average value of a module A, B, C if necessary iteratively.

The result is a durable synchronisation of all storage cells 12 substantially at any time which enables maximum storage usage without detriment to the lifetime of the system for storing electric energy 10.

This is especially advantageous when a threshold voltage can be achieved for the whole system or the whole module only for a very short while in applications with cyclic operation, such as for example with hybrid drives. It may then happen that said threshold voltage cannot be achieved for a significant length of time any longer because failing recuperation with simultaneous strong boost operation, the storage device is not filled up to the threshold voltage any longer. This problem is eliminated by the solution according to the invention since the switching element 16 designed as a threshold switch adapts itself in real-time via the appropriate control input 18, continuously as regards its threshold value, i.e. also during the cyclic operation for example in a recovery process during which the voltage increases due to the energy storage, for instance according to the average cell voltage which is derived from the total voltage and the number of all cells or from the average cell voltage of a module or of a submodule.

1-14. (canceled)

15. A system for storing electric energy, comprising a plurality of storage cells, which have each an operating voltage, whereas an electrical load as well as a switching element in series with the load are arranged in parallel to a storage cell and whereas the switching element is closed when reaching or exceeding a threshold voltage,
characterised in that
the system includes a control device, which is arranged in order to adjust the threshold voltage depending on a voltage value established from operating voltages of the plurality of the storage cells.

16. The system of claim 15, characterised in that a central control device is provided for several storage cells.

17. The system of claim 15, characterised in that the control device is designed to form a common voltage value from a plurality of operating voltages of storage cells and to adjust the threshold voltage of the plurality of storage cells to a value which encompasses the common voltage value.

18. The system of claim 16, characterised in that the control device is designed to form a common voltage value from a plurality of operating voltages of storage cells and to adjust the threshold voltage of the plurality of storage cells to a value which encompasses the common voltage value.

19. The system according to claim 15, characterised in that the control device adjusts the threshold voltage at determined intervals.

20. The system according to claim 16, characterised in that the control device adjusts the threshold voltage at determined intervals.

21. The system according to claim 17, characterised in that the control device adjusts the threshold voltage at determined intervals.

22. The system according to claim 18, characterised in that the control device adjusts the threshold voltage at determined intervals.

23. The system of claim 15, characterised in that the control device continuously controls the threshold voltage.

24. The system of claim 16, characterised in that the control device continuously controls the threshold voltage.

25. The system of claim 17, characterised in that the control device continuously controls the threshold voltage.

26. The system of claim 15, characterised in that the switching element has a control input so as to control the threshold voltage.

27. The system of claim 15, characterised in that the control device is connected to the storage cell by means of a bus line.

28. The system of claim 15, characterised in that the load is a resistance and/or that the storage cell is a supercapacitor.

29. The system of claim 15, characterised in that the switching element is a threshold switch.

30. The system of claim 15, characterised in that the control device activates the switching element via a contact-free transmission device.

31. The system of claim 30, characterised in that the contact-free transmission device includes a buffer amplifier.

32. The system of claim 15, characterised in that the system is used in an energy storage device, in particular for hybrid drives.

33. A storage cell for storing electric energy, with an electrical load which is arranged parallel to a storage cell as well as a switching element which is arranged in series with the load, whereas the switching element is closed when reaching or exceeding a threshold voltage,
characterised in that
that the switching element has a control input for controlling the threshold voltage.

34. A method for controlling a system arranged for storing electric energy with a plurality of storage cells, which have each an operating voltage, whereas an electrical load as well as a switching element in series with the device are arranged in parallel to a storage cell, including the steps of:
charging the storage cells,
comparing the operating voltage of a storage cell with a threshold voltage and closing the switching element, in case when the operating voltage has reached or exceeded the threshold voltage,
characterised by the step:
adjusting the threshold voltage depending on a voltage value determined from operating voltages of the plurality of the storage cells.
